(19) United States
(12) Patent Application Publication
(10) Pub. No.: US 2021/0371041 A1
(43) Pub. Date: Dec. 2, 2021

(54) CLEARANCE PACKING ASSEMBLY FOR A FRONT FORK OF A BICYCLE

(71) Applicant: LEE CHI ENTERPRISES CO., LTD., Changhua City (TW)

(72) Inventors: Wen-Tsung LIU, Changhua City (TW); Ching-Lin TUNG, Changhua City (TW)

(21) Appl. No.: 17/306,981

(22) Filed: May 4, 2021

(30) Foreign Application Priority Data
May 29, 2020 (TW) 109206734

(51) Int. Cl. B62K 19/40

(52) U.S. Cl. CPC B62K 19/40

(57) ABSTRACT

A clearance packing assembly for a front fork of a bicycle has a ring set, a packing ring, and a locking ring. The ring seat has an outer threaded surface. The packing ring has an inner side surface engaging with the outer threaded surface of the screwing portion via an inner thread. The locking ring has an inner side surface engaging with the outer threaded surface of the screwing portion via an inner thread. By turning the locking ring to move toward the packing ring, the locking ring abuts against the packing ring. The clearance packing assembly is independent from a handlebar stem, a fork stem of the front fork and a head tube of a bicycle frame and can be widely used on different handlebar stems, so to adjust clearance between the head tube and the handlebar stem.

### BACKGROUND OF THE INVENTION

### 1. Field of the Invention

The present invention relates to a fitting component of accessories to a bicycle, especially to a clearance packing assembly that is used along with a handlebar stem of the bicycle.

### 2. Description of the Prior Art(s)

With the popularization of energy saving, carbon reduction and bike sharing, it is trendy to ride bicycles and the bicycles are becoming more and more popular. Related industries that produce bicycle parts are technically mature. Consumers have higher and higher requirements for qualities of the bicycle parts and are also more willing to seek and install the bicycle parts that suit their own usage habits. Therefore, the market is flooded with the bicycle part of various standards. In order to provide the customers with the best user experiences, manufacturers of the bicycle parts are all working on improving designs of the bicycle parts, so as to provide the customers with the bicycle part of different standards.

Generally, as shown in FIG. 7, a fork stem 100 of a front fork of a bicycle is mounted through a head tube 101 of a bicycle frame, is inserted into an insertion recess of a handlebar stem 102, and then is secured in the insertion recess through a tube insert 103 and a bolt 104. The tube insert 103 is securely mounted in the fork stem 100. The bolt 104 is mounted through a bottom of the insertion recess of the handlebar stem 102 and the tube inset, and is rotatably connected with the tube insert 103 via threads. Thus, the fork stem 100 and the handlebar stem 102 can be connected together. Since the handlebar stem 102 is secured in the insertion recess of the handle stem 102 through the tube insert 103 and the bolt 104, cables of the bicycle can only be routed outside the bicycle frame and the handlebar stem 102, causing the bicycle having a messy appearance. Therefore, a handlebar stem allowing cables of a bicycle to be routed inside the handlebar stem is provided.

However, different handlebar stems have different standards and structural designs. For the handlebar stem allowing the cables to be routed therein, clearance formed between the handlebar stem and a head tube of a bicycle frame easily. Thus, a conventional packing element mounted on a lower end of the handlebar stem is needed. Specifically, the lower end of the handlebar stem is provided with an internal thread and the conventional packing element is provided with an external thread, such that the conventional packing element is connected with the lower end of the handlebar stem via the external thread and the internal thread. By turning the conventional packing element relative to the handlebar stem, the clearance between the handlebar stem and the head tube of the bicycle frame can be eliminated.

Since the conventional packing element is connected with the lower end of the handlebar stem only via the external thread and the internal thread, the conventional packing element is loosened easily due to vibration during riding. Consequently, the clearance between the handlebar stem and the head tube is unable to be eliminated surely, and safety problems would be caused. In addition, since the conventional packing element is connected with the handlebar stem directly via the external thread and the internal thread, the conventional packing element can only be used along with the handlebar stem having specific standard and is unable to be mounted to different kinds of handlebar stems, causing the use of the conventional packing element being restricted.

To overcome the shortcomings, the present invention provides a clearance packing assembly for a front fork of a bicycle to mitigate or obviate the aforementioned problems.

### SUMMARY OF THE INVENTION

The main objective of the present invention is to provide a clearance packing assembly for a front fork of a bicycle. The clearance packing assembly has a ring set, a packing ring, and a locking ring. The ring seat has a screwing portion and a mounting hole. The screwing portion has an outer threaded surface formed as an outer circumference of the screwing portion. The mounting hole is surrounded by the screwing portion. The packing ring is annular and has an inner side surface engaging with the outer threaded surface of the screwing portion via an inner thread. The locking ring is annular and has an inner side surface engaging with the outer threaded surface of the screwing portion via an inner thread. By turning the locking ring to move toward the packing ring, the locking ring abuts against the packing ring.

Since the clearance packing assembly is formed by assembling three pieces, i.e. the ring seat, the packing ring and the locking ring, that are independent from a handlebar stem, a fork stem of the front fork and a head tube of a bicycle frame, the clearance packing assembly of the present invention can be widely used on different handlebar stems, so to adjust clearance between the head tube and the handlebar stem.

Moreover, with the locking ring abutting against the packing ring to allow the packing ring to abut up against the handlebar stem and the ring seat to abut down against the head tube of the bicycle frame, the locking ring further locks a position of the packing ring. The packing ring is not loosed easily due to vibration of the bicycle while riding. Accordingly, it can be ensured that the clearance packing assembly is able to eliminated clearance between the handlebar stem and the head tube of the bicycle frame and safety of riding the bicycle is improved.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a clearance packing assembly for a front fork of a bicycle in accordance with the present invention;

FIG. 2 is an exploded perspective view of the clearance packing assembly in FIG. 1;

FIG. 3 is an operational enlarged side view in cross-section of the clearance packing assembly in FIG. 1;

FIG. 4 is another operational enlarged side view in cross-section of the clearance packing assembly in FIG. 1;

FIG. 5 is another operational perspective view of the clearance packing assembly in FIG. 2, showing a cable of an electric bicycle being routed through the clearance packing assembly and a handlebar stem;

FIG. 6 is an operational side view in cross-section of the clearance packing assembly in FIG. 2, showing the cable of the electric bicycle being routed through the clearance packing assembly and the handlebar stem; and

FIG. 7 is an enlarged cross-sectional side view of a conventional bicycle in accordance with the prior art.

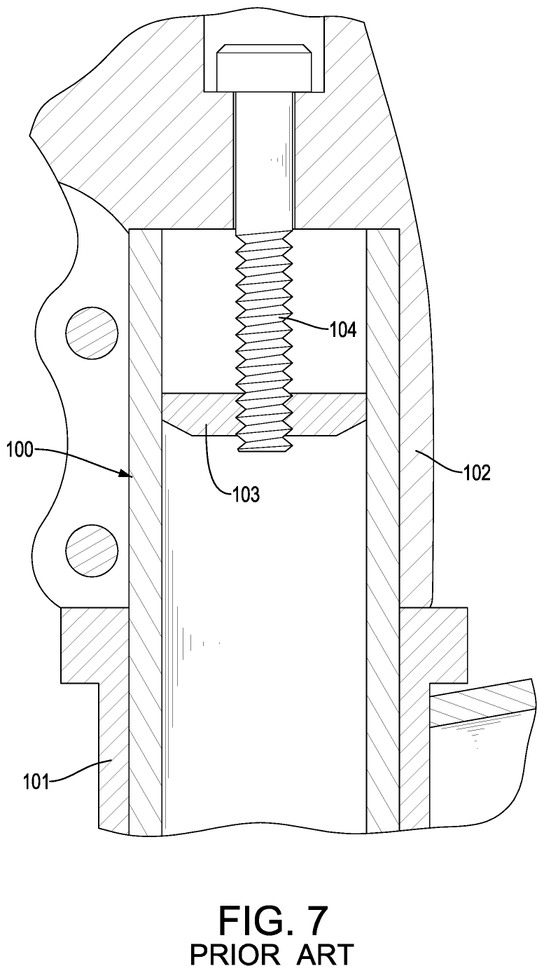

### DETAILED DESCRIPTION OF THE PREFERRED EMBODIMENTS

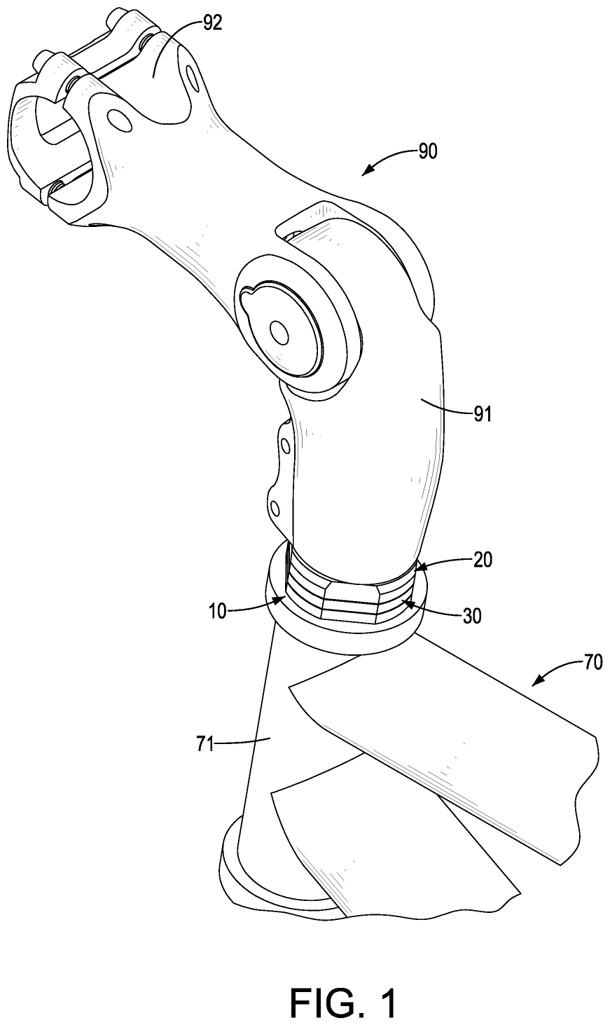

With reference to FIG. 1, a clearance packing assembly in accordance with the present invention is mounted on a front fork of a bicycle, is disposed between a handlebar stem and a head tube, and is for packing clearance between the handlebar stem and the head tube. The clearance packing assembly comprises a ring seat 10, a packing ring 20, and a locking ring 30.

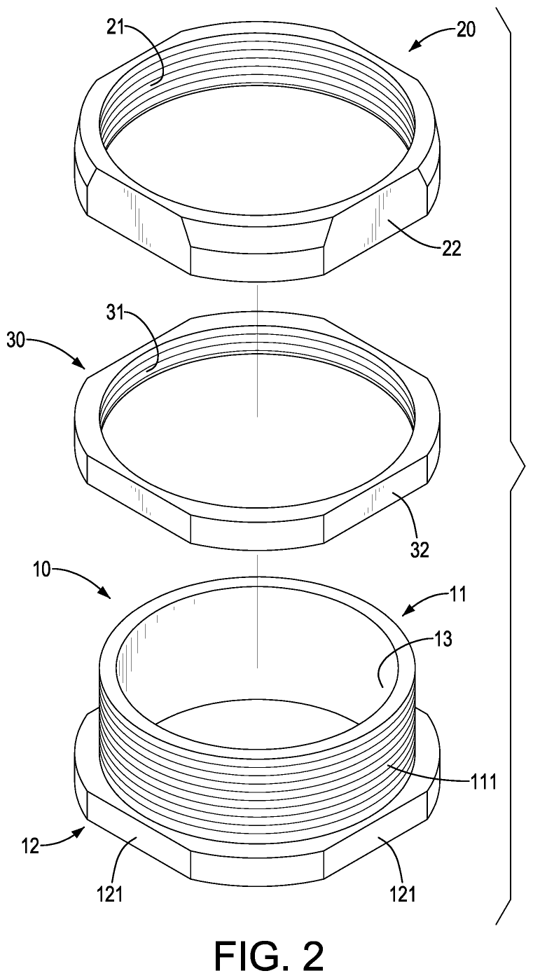

With further reference to FIG. 2, the ring seat 10 has a screwing portion 11, a flange 12, and a mounting hole 13. The screwing portion 11 has two opposite ends and an outer threaded surface 111. An axial direction of the ring seat 10 is defined through the two opposite ends of the screwing portion 11. The outer threaded surface 111 is formed as an outer circumference of the screwing portion 11. The flange 12 is disposed around one of the ends of the screwing portion 11 and is provided with at least one engaging surface 121. In order to be fitted in a U-shaped opening of an open-end wrench or an enclosed opening of a box-end wrench, the at least one engaging surface 121 of the flange 12 preferably includes four engaging surfaces 121. The four engaging surfaces 121 of the flange 12 are arranged around the screwing portion 11 at equal circumferential angle intervals. Thus, when the open-end wrench or the box-end wrench is mounted on the flange 12, the open-end wrench or the box-end wrench holds on two of the engaging surfaces 121 that are oppositely disposed on the flange 12, so as to turn the ring seat 10. The mounting hole 13 is surrounded by the screwing portion 11 and the flange 12 and extends along the axial direction of the ring seat 10. An inner diameter of the mounting hole 13 matches a fork stem of the front fork.

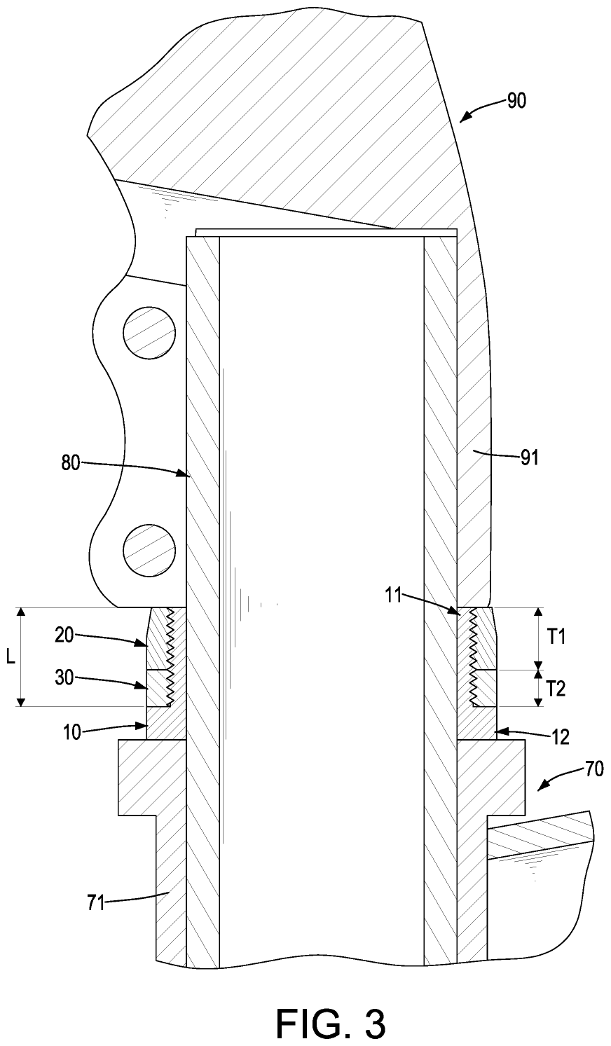

With reference to FIGS. 1 and 3, a bicycle frame 70 of the bicycle includes a head tube 71. The handlebar stem 90 has a mounting tube 91 tightly connected with the fork stem 80 and a handlebar mount 92 used for mounting a handlebar. The fork stem 80 is mounted through the head tube 71 and protrudes into the mounting tube 91 of the handlebar stem 90. The ring seat 10 is mounted around the fork stem 80 and is disposed between the head tube 71 and the mounting tube 71.

With reference to FIG. 2, the packing ring 20 is annular and has an inner side surface and outer side surface. The inner side surface of the packing ring 20 faces the outer threaded surface 111 of the screwing portion 11 and is provided with an inner thread 21 engaging with the outer threaded surface 111 of the screwing portion 11. The outer side surface of the packing ring 20 is provided with at least one engaging surface 22.

In order to be fitted in the U-shaped opening of the open-end wrench or the enclosed opening of a box-end wrench, the at least one engaging surface 22 on the outer side surface of the packing ring 20 preferably includes four engaging surfaces 22. The four engaging surfaces 22 of the packing ring 20 are arranged at equal circumferential angle intervals. Thus, when the open-end wrench or the box-end wrench is mounted on the packing ring 20, the open-end wrench or the box-end wrench holds on two of the engaging surfaces 22 that are oppositely disposed on the packing ring 20, so as to turn the packing ring 20.

As shown in FIG. 1, the packing ring 20 is screwed onto the screwing portion 11 of the ring seat 10.

The locking ring 30 is annular and has an inner side surface and an outer side surface. A height T2 of the locking ring 30 is smaller than a height T1 of the packing ring 20. The inner side surface of the locking ring 30 is provided with an inner thread 31 engaging with the outer threaded surface 111 of the screwing portion 11. The outer side surface of the locking ring 30 is provided with at least one engaging surface 32. Preferably, the at least one engaging surface 32 on the outer side surface of the locking 30 includes four engaging surfaces 32. The four engaging surfaces 32 of the locking ring 30 are arranged at equal circumferential angle intervals. Through the outer threaded surface 111 of the screwing portion 11 of the ring seat 10, the locking ring 30 is able to abut against the packing ring 20 when the locking ring 30 is turned to move toward the locking ring 20.

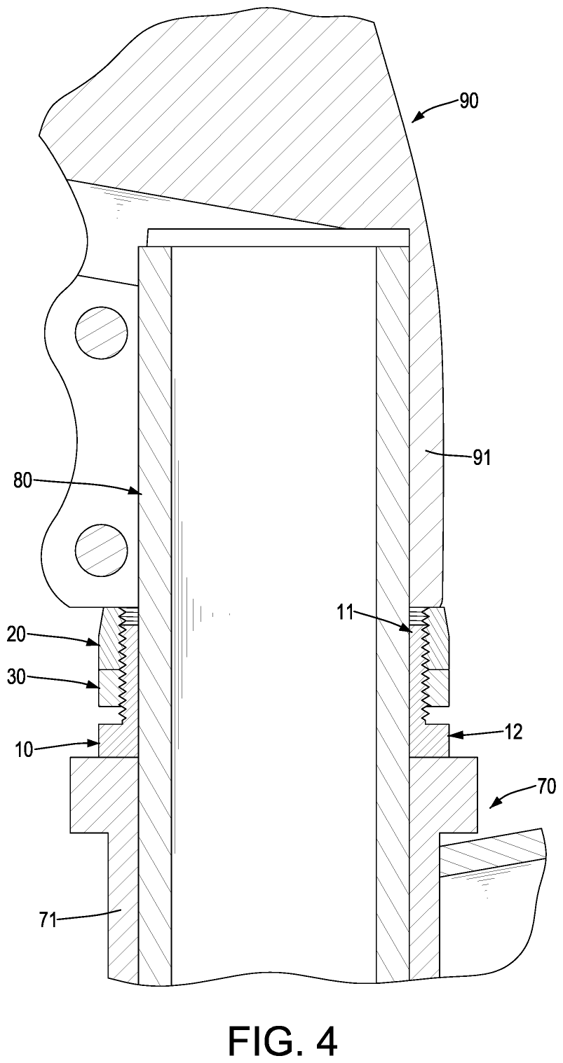

With further reference to FIGS. 3 and 4, in the preferred embodiment, the packing ring 20 and the locking ring 30 are different in height. Specifically, the height T1 of the packing ring 20 may be greater than the height T2 of the locking ring 30. Preferably, a sum of the height T1 of the packing ring 20 and the height T2 of the locking ring 30 is equal to a length L of the screwing portion 11. The flange 12 of the ring seat 10 abuts down against an upper edge of the head tube 71. The packing ring 20 is adjusted by being turned to abut up against a lower edge of the mounting tube 91 of the handlebar stem 90. With the upward and downward abutments, clearance around the fork stem 80 of the front fork and between the head tube 71 and the mounting tube 91 can be eliminated. Moreover, when the packing ring 20 has abutted against the mounting tube 91 of the handlebar stem 90, the locking ring 30 can be further turned to abut against and lock position of the packing ring 20, so as to avoid loosening of the packing ring 20, which is due to vibration of the bicycle when the bicycle is traveling.

As shown in FIGS. 2 and 3, in the preferred embodiment, the packing ring 20 and the locking ring 30 are different in height. Specifically, the packing ring 20 and the locking ring 30 may have the same height.

In the preferred embodiment, the sum of the height T1 of the packing ring 20 and the height T2 of the locking ring 30 is equal to the length L of the screwing portion 11. Specifically, the length L of the screwing portion 11 may also be greater than the sum of the height T1 of the packing ring 20 and the height T2 of the locking ring 30, such that the clearance packing assembly of the present invention can be used more widely to adjust the clearance between the head tube 71 and the mounting tube 91.

In the preferred embodiment, the clearance packing assembly of the present invention is formed by assembling three pieces. Specifically, respective number of the packing ring 20 or the locking ring 30 may also be increased according to the clearance between the head tube 71 and the mounting tube 91.

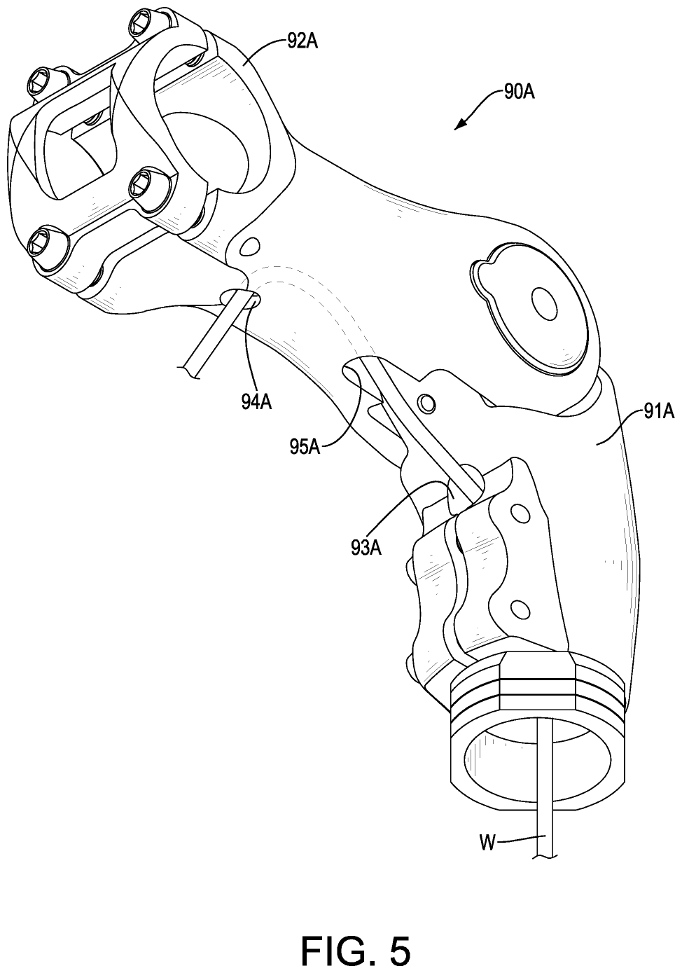

With further reference to FIG. 5, the clearance packing assembly of the present invention may be used along with a handlebar stem 90A of an electric bicycle and the handlebar stem 90A is configured with an internal cable. In addition to a mounting tube 91A and a handlebar mount 92A, the handlebar stem 90A further has a first through hole 93A, a second through hole 94A and a passing notch 95A. The first through hole 93A is defined through the handlebar stem 90A and is disposed at the mounting tube 91A. The second through hole 94A is defined through the handlebar stem 90A and is disposed adjacent to the handlebar mount 92A. The passing notch 95A is defined through the handlebar stem 90A and is disposed between the first through hole 93A and the second through hole 94A.

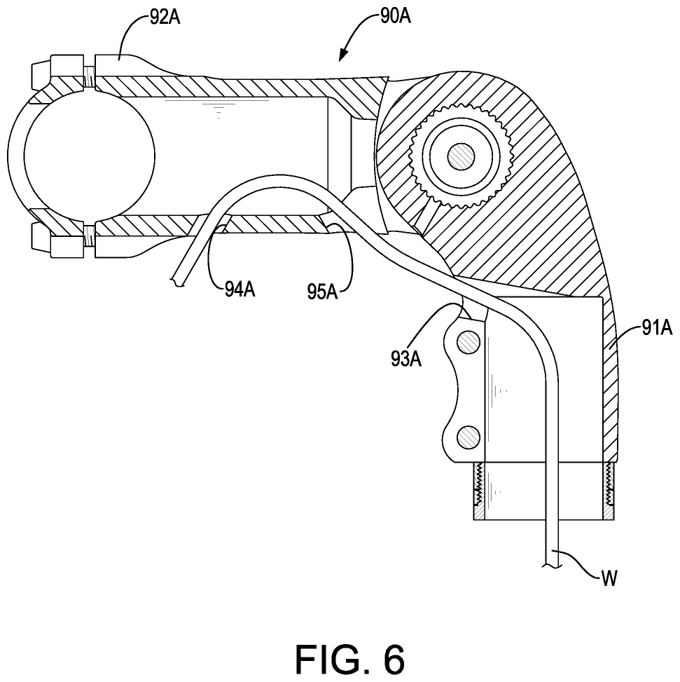

As shown in FIGS. 5 and 6, a cable W passes through the ring seat 10, the packing ring 20 and the locking ring 30 of clearance packing assembly of the present invention to enter the mounting tube 91A. Then the cable W is mounted through the first through hole 93A and passes through the passing notch 95A to enter the handlebar stem 90A, and then the cable W protrudes out of the handlebar stem 90A through the second through hole 94A.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A clearance packing assembly for a front fork of a bicycle, and the clearance packing assembly comprising:
a ring seat having
a screwing portion having an outer threaded surface, and the outer threaded surface formed as an outer circumference of the screwing portion; and
a mounting hole surrounded by the screwing portion;
a packing ring being annular and having an inner side surface, and the inner side surface of the packing ring engaging with the outer threaded surface of the screwing portion via an inner thread; and
a locking ring being annular and having an inner side surface, and the inner side surface of the locking ring engaging with the outer threaded surface of the screwing portion via an inner thread;
wherein by turning the locking ring to move toward the packing ring, the locking ring abuts against the packing ring.

2. The clearance packing assembly as claimed in claim 1, wherein the ring seat further has a flange disposed around one of two opposite ends of the screwing portion.

3. The clearance packing assembly as claimed in claim 2, wherein the flange of the ring seat is provided with at least one engaging surface.

4. The clearance packing assembly as claimed in claim 3, wherein the at least one engaging surface of the flange of the ring seat includes four engaging surfaces arranged around the screwing portion at equal circumferential angle intervals.

5. The clearance packing assembly as claimed in claim 2, wherein a sum of a height of the packing ring and a height of the locking ring is greater than or equal to a length of the screwing portion.

6. The clearance packing assembly as claimed in claim 5, wherein the height of the locking ring is smaller than the height of the packing ring.

7. The clearance packing assembly as claimed in claim 1, wherein
an outer side surface of the packing ring is provided with at least one engaging surface; and
an outer side surface of the locking ring is provided with at least one engaging surface.

8. The clearance packing assembly as claimed in claim 2, wherein
an outer side surface of the packing ring is provided with at least one engaging surface; and
an outer side surface of the locking ring is provided with at least one engaging surface.

9. The clearance packing assembly as claimed in claim 3, wherein
an outer side surface of the packing ring is provided with at least one engaging surface; and
an outer side surface of the locking ring is provided with at least one engaging surface.

10. The clearance packing assembly as claimed in claim 4, wherein
an outer side surface of the packing ring is provided with at least one engaging surface; and
an outer side surface of the locking ring is provided with at least one engaging surface.

11. The clearance packing assembly as claimed in claim 5, wherein
an outer side surface of the packing ring is provided with at least one engaging surface; and
an outer side surface of the locking ring is provided with at least one engaging surface.

12. The clearance packing assembly as claimed in claim 6, wherein
an outer side surface of the packing ring is provided with at least one engaging surface; and
an outer side surface of the locking ring is provided with at least one engaging surface.

13. The clearance packing assembly as claimed in claim 7, wherein
the at least one engaging surface on the outer side surface of the packing ring includes four engaging surfaces arranged at equal circumferential angle intervals; and
the at least one engaging surface on the outer side surface of the locking includes four engaging surfaces arranged at equal circumferential angle intervals.

14. The clearance packing assembly as claimed in claim 8, wherein
the at least one engaging surface on the outer side surface of the packing ring includes four engaging surfaces arranged at equal circumferential angle intervals; and
the at least one engaging surface on the outer side surface of the locking includes four engaging surfaces arranged at equal circumferential angle intervals.

15. The clearance packing assembly as claimed in claim 9, wherein
the at least one engaging surface on the outer side surface of the packing ring includes four engaging surfaces arranged at equal circumferential angle intervals; and
the at least one engaging surface on the outer side surface of the locking includes four engaging surfaces arranged at equal circumferential angle intervals.

16. The clearance packing assembly as claimed in claim 10, wherein
the at least one engaging surface on the outer side surface of the packing ring includes four engaging surfaces arranged at equal circumferential angle intervals; and
the at least one engaging surface on the outer side surface of the locking includes four engaging surfaces arranged at equal circumferential angle intervals.

17. The clearance packing assembly as claimed in claim 11, wherein
the at least one engaging surface on the outer side surface of the packing ring includes four engaging surfaces arranged at equal circumferential angle intervals; and
the at least one engaging surface on the outer side surface of the locking includes four engaging surfaces arranged at equal circumferential angle intervals.

18. The clearance packing assembly as claimed in claim 12, wherein
the at least one engaging surface on the outer side surface of the packing ring includes four engaging surfaces arranged at equal circumferential angle intervals; and
the at least one engaging surface on the outer side surface of the locking includes four engaging surfaces arranged at equal circumferential angle intervals.
